(19) United States
(12) Patent Application Publication
(10) Pub. No.: US 2025/0316758 A1
(43) Pub. Date: Oct. 9, 2025

(54) COMPOUND, ELECTROLYTE INCLUDING THE SAME FOR RECHARGEABLE LITHIUM BATTERY, AND RECHARGEABLE LITHIUM BATTERY INCLUDING THE SAME

(71) Applicant: Samsung SDI Co., Ltd., Yongin-si (KR)

(72) Inventors: PAVEL SHATUNOV, Yongin-si (KR); Seungryong OH, Yongin-si (KR); Myunghoon KIM, Yongin-si (KR); Aeran KIM, Yongin-si (KR); Dahyun KIM, Yongin-si (KR); SANGHOON KIM, Yongin-si (KR); Jeongmin SHIN, Yongin-si (KR); Olga TSAY, Yongin-si (KR)

(21) Appl. No.: 18/922,099

(22) Filed: Oct. 21, 2024

(30) Foreign Application Priority Data
Apr. 4, 2024 (KR) 10-2024-0045786

(51) Int. Cl. H01M 10/0567; H01M 4/02; H01M 4/38; H01M 4/525; H01M 4/583; H01M 10/0525; H01M 10/0568; H01M 10/0569

(52) U.S. Cl. CPC H01M 10/0567; H01M 4/387; H01M 4/525; H01M 4/583; H01M 10/0525; H01M 10/0568; H01M 10/0569; H01M 2004/027; H01M 2004/028; H01M 2300/004

(57) ABSTRACT

A rechargeable lithium battery includes an electrolyte. The electrolyte includes a non-aqueous organic solvent, a lithium salt, and an additive represented by Chemical Formula 1.

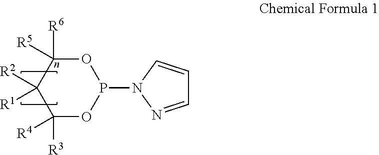

### CROSS-REFERENCE TO RELATED APPLICATION

The present application claims priority to and the benefit of Korean Patent Application No. 10-2024-0045786, filed on Apr. 4, 2024, in the Korean Intellectual Property Office, the entire content of which is incorporated herein by reference.

### BACKGROUND

### 1. Field

Embodiments of the present disclosure described herein are related to an electrolyte for a rechargeable lithium battery, an electrolyte additive, and a rechargeable lithium battery including the same.

### 2. Description of the Related Art

Recently, with the rapid spread of batter-using electronic devices (that use batteries), such as mobile phones, laptop computers, and/or electric vehicles, there is a rapidly increasing demand or desire for rechargeable batteries with relatively high energy density and high capacity. Therefore, intensive research has been conducted to improve performance of rechargeable lithium batteries.

A rechargeable lithium battery includes a positive electrode, a negative electrode, and an electrolyte. The positive and negative electrodes include an active material in which intercalation and deintercalation are possible, and generates electrical energy caused by oxidation and reduction reactions if (e.g., when) lithium ions are intercalated and deintercalated.

A lithium salt dissolved in a non-aqueous organic solvent is used as the electrolyte of the rechargeable lithium battery. Characteristics of the rechargeable lithium battery are exhibited by complex reactions between the positive electrode and the electrolyte and between the negative electrode and the electrolyte. Accordingly, the use of an appropriate or suitable electrolyte is an important variable for improving the rechargeable lithium battery.

### SUMMARY

Aspects according to one or more embodiments are directed toward an electrolyte for a rechargeable lithium battery having improved high-temperature stability.

Aspects according to one or more embodiments are directed toward a rechargeable lithium battery including the electrolyte.

Additional aspects will be set forth in part in the description which follows and, in part, will be apparent from the description, or may be learned by practice of the presented embodiments of the present disclosure.

According to one or more embodiments of the present disclosure, an electrolyte for a rechargeable lithium battery may include: a non-aqueous organic solvent; a lithium salt; and an additive represented by Chemical Formula 1.

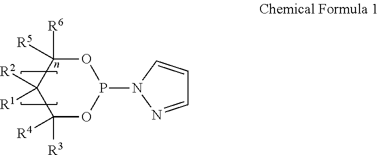

In Chemical Formula 1,
R¹ to R⁶ may each independently be hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n may be an integer of 0 or 1.

According to one or more embodiments of the present disclosure, a compound represented by Chemical Formula 2.

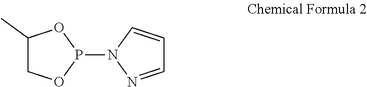

According to one or more embodiments of disclosure, a rechargeable lithium battery may include: a positive electrode that includes a positive electrode active material; a negative electrode that includes a negative electrode active material; and the above-mentioned electrolyte for the rechargeable lithium battery.

### BRIEF DESCRIPTION OF DRAWINGS

FIG. 1 illustrates a conceptual diagram showing a rechargeable lithium battery according to one or more embodiments of invention the present disclosure.

FIGS. 2-5 each illustrate a diagram showing a rechargeable lithium battery according to one or more embodiments, in which FIG. 2 shows a cylindrical battery, FIG. 3 shows a prismatic battery, and FIGS. 4 and 5 show pouch-type or kind batteries.

FIG. 6 illustrates a graph showing 1H NMR spectrum results of a compound according to Synthesis Example 1.

### DETAILED DESCRIPTION

In order to sufficiently understand the configuration and aspect of the present disclosure, one or more embodiments of the present disclosure will be described in more detail with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components are exaggerated for effectively explaining the technical contents. Like reference numerals refer to like elements throughout, and duplicative descriptions thereof may not be provided the specification.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method suitable to those skilled in the art, for example, by a particle size analyzer, a transmission electron microscope (TEM) image, or a scanning electron microscope (SEM) image. In one or more embodiments, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a distribution solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device. Also, in the present disclosure, when particles are spherical, “diameter” indicates a particle diameter or an average particle diameter, and when the particles are non-spherical, the “diameter” indicates a major axis length or an average major axis length.

As utilized herein, expressions such as “at least one of”, “one of”, and “of (e.g., selected from among)”, when preceding a list of elements, modify the entire list of elements and do not modify the individual elements of the list. For example, “at least one of a, b or c”, “at least one selected from among a, b and c”, and/or the like, may indicate only a, only b, only c, both (e.g., simultaneously) a and b, both (e.g., simultaneously) a and c, both (e.g., simultaneously) b and c, all of a, b, and c, or variations thereof.

The term utilized herein is intended to describe only a specific embodiment and is not intended to limit the present disclosure. As utilized herein, the singular forms “a,” “an,” and “the” are intended to include the plural forms, including “at least one,” unless the content (e.g., amount) clearly indicates otherwise. “At least one” should not be construed as being limited to the singular. As utilized herein, the term “and/or” includes any and all combinations of one or more of the associated listed items. The terms “includes,” “including,” “comprises,” and/or “comprising,” when utilized in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be utilized herein to easily describe one element or feature's relationship to another element or feature. It will be understood that the spatially relative terms are intended to encompass different orientations of a device in utilize or operation in addition to the orientation illustrated in the drawings. For example, when a device in the drawings is turned over, elements described as “below” or “beneath” other elements or features would then be “above” or “over” the other elements or features. In some embodiments, the example term “below” may encompass both (e.g., simultaneously) orientations of above and below. The device may be otherwise oriented (rotated 90 degrees or at other orientations), and the spatially relative terms utilized herein may be interpreted accordingly.

As utilized herein, the term “substantially” and similar terms are utilized as terms of approximation and not as terms of degree, and are intended to account for the inherent deviations in measured or calculated values that would be recognized by those of ordinary skill in the art. Also, the term “about” and similar terms, when utilized herein in connection with a numerical value or a numerical range, are inclusive of the stated value and a value within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A person of ordinary skill in the art would appreciate, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the context of the present application and unless otherwise defined, the terms “use,” “using,” and “used” may be considered synonymous with the terms “utilize,” “utilizing,” and “utilized,” respectively.

Further, the use of “may” when describing embodiments of the inventive concept refers to “one or more embodiments of the inventive concept.” Also, the term “exemplary” is intended to refer to an example or illustration.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

For example, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluomethyl group, or a naphthyl group.

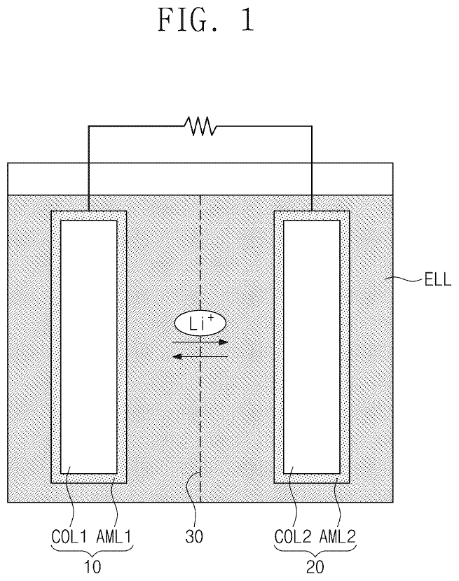

FIG. 1 illustrates a conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material.

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. Amounts of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be used to provide an electrode with conductivity, and any suitable conductive material without causing chemical change of a battery may be used as the conductive material to constitute the battery. The conductive material may include, for example, a carbon-based material such as natural graphite, artificial graphite, carbon black, acetylene black, Ketjenblack, carbon fiber, carbon nano-fiber, and carbon nano-tube; a metal powder or metal fiber containing one or more of copper, nickel, aluminum, and silver; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from among cobalt, manganese, nickel, and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a (e.g., any suitable) combination thereof.

For example, the positive electrode active material may include a compound expressed by any one selected from among chemical formulae (below). LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GeO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}GbO₂ (where 0.90≤a≤1.8 and 0.001≤b≤0.1); LiₐMn₂GbO₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is Ni, Co, Mn, and/or a (e.g., any suitable) combination thereof, X is Al, Ni, Co, Mn, Cr, Fe, Mg, Sr, V, a rare-earth element, and/or a (e.g., any suitable) combination thereof, D is 0, F, S, P, and/or a (e.g., any suitable) combination thereof, G is Al, Cr, Mn, Fe, Mg, La, Ce, Sr, V, and/or a (e.g., any suitable) combination thereof, and L¹ is Mn, Al, and/or a (e.g., any suitable) combination thereof.

For example, the positive electrode active material may be a high nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 (e.g., in a total of 100 wt %) may include a negative electrode active material of about 90 wt % to about 99 wt %, a binder of about 0.5 wt % to about 5 wt %, and a conductive material of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a (e.g., any suitable) combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material may be used to provide an electrode with conductivity, and any suitable conductive material without causing chemical change of a battery may be used as the conductive material to constitute the battery. For example, the conductive material may include a carbon-based material such as natural graphite, artificial graphite, carbon black, acetylene black, Ketjenblack, carbon fiber, carbon nano-fiber, and carbon nano-tube; a metal powder or metal fiber including one or more of copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, silicon-carbon composite, SiOx (where 0<x≤2), Si-Q alloy (where Q is alkali metal, alkaline earth metal, Group 13 element, Group 14 element (except for Si), Group 15 element, Group 16 element, transition metal, a rare-earth element, and/or a (e.g., any suitable) combination thereof), and/or a (e.g., any suitable) combination thereof. The Sn-based negative electrode active material may include Sn, SnOx (0<x≤2), e.g., SnO₂, a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on type or kind of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, and polytetrafluoroethylene (e.g., Teflon), and polytetrafluoroethylene, or may be a copolymer or mixture including two or more of the materials mentioned above.

The organic material may include a polyvinylidenefluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be present as mixed in one coating layer or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, caprolactone, or propyl propionate (PP).

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluoro(oxalato)borate(LiDFOB), lithium difluorobis(oxalato)phosphate (LiDFBOP), and lithium bis(oxalato) borate (LiBOB).

The following will describe in more detail an electrolyte for a rechargeable lithium battery according to one or more embodiments of the present disclosure.

An electrolyte for a rechargeable lithium battery according to one or more embodiments may include a non-aqueous organic solvent, a lithium salt, and an additive represented by Chemical Formula 1.

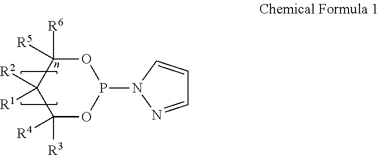

In Chemical Formula 1,
R¹ to R⁶ may each independently be hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.
n may be an integer of 0 or 1.

The electrolyte may be manufactured by a mixing process in which a lithium salt is dissolved in a non-aqueous organic solvent and the additive expressed by Chemical Formula 1 above is added to mix. The electrolyte mixing process is a suitable process in electrolyte fabrication field, and a person skilled in the art will be able to appropriately or suitably select and use.

The non-aqueous organic solvent may include at least one selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous organic solvent may be a mixed solvent of ethylmethyl carbonate (EMC), ethylene carbonate (EC), and dimethyl carbonate (DMC).

In one or more embodiments, the ethylmethyl carbonate (EMC) solvent may be included in an amount of about 5 vol % to about 15 vol % relative to the total volume of the non-aqueous organic solvent. The ethylene carbonate (EC) may be included in an amount of about 5 vol % to about 40 vol % relative to the total volume of the non-aqueous organic solvent. The dimethyl carbonate (DMC) may be included in an amount of about 5 vol % to about 90 vol % relative to the total volume of the non-aqueous organic solvent. In one or more embodiments, the ethylmethyl carbonate (EMC) may be included in an amount of about 5 vol % to about 15 vol % relative to the total volume of the non-aqueous organic solvent. The ethylene carbonate (EC) may be included in an amount of about 10 vol % to about 30 vol % relative to the total volume of the non-aqueous organic solvent. The dimethyl carbonate (DMC) may be included in an amount of about 50 vol % to about 80 vol % relative to the total volume of the non-aqueous organic solvent.

In one or more embodiments, the lithium salt may include LiPF₆.

The lithium salt may have a concentration of about 0.1 M to about 2.0 M. For example, the lithium salt may have a concentration of equal to or greater than about 0.5 M or about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain its conductivity and viscosity.

### Additive

The additive according to the present disclosure may be represented by Chemical Formula 1.

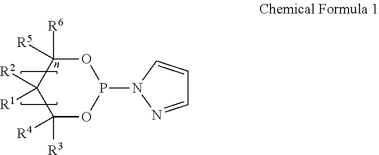

In Chemical Formula 1,
R¹ to R⁶ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.
n may be an integer of 0 or 1. n being zero may refer to a direct bond. For example, if (e.g., when) n is zero, a cyclic phospholane derivative portion containing a —OPO— functional group may be a pentagonal ring.

In one or more embodiments, Chemical Formula 1 above may be represented by Chemical Formula 1A or 1B.

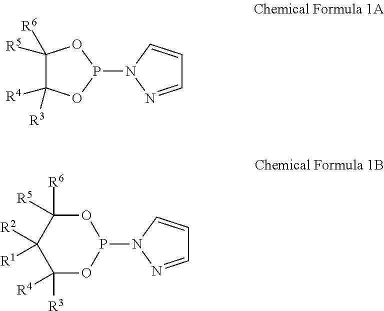

In Chemical Formula 1A and Chemical Formula 1B,
R¹ to R⁶ may each independently be hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In one or more embodiments, R³ and R⁴ of Chemical Formula 1A above may each be hydrogen.

At least one selected from among R⁵ and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In one or more embodiments, the additive represented by Chemical Formula 1 above may be at least one selected from among compounds listed in Group 1. For example, the additive represented by Chemical Formula 1 above may be at least one selected from among 1-(1,3,2-dioxaphospholan-2-yl)-1H-1,2,4-pyrazole and 1-(4-methyl-1,3,2-dioxaphospholan-2-yl)-1H-1,2,4-pyrazole.

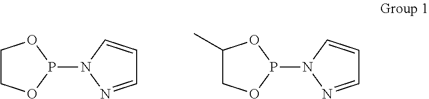

In one or more embodiments, the additive represented by Chemical Formula 1 above may be a compound represented by Chemical Formula 2.

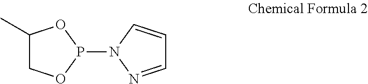

An amount of the additive expressed by Chemical Formula 1 above may be about 0.01 to about 5.0 parts by weight relative to 100 parts by weight (which can also be expressed as 100 wt %) of the electrolyte for a rechargeable lithium battery. For example, the amount of the additive may be about 0.1 to about 3.5 parts by weight or about 0.25 to about 3.5 parts by weight relative to 100 parts by weight of the electrolyte for a rechargeable lithium battery. An amount of the additive may refer to a weight of the additive included in the electrolyte relative to the total weight of the electrolyte. When the amount of the additive satisfies the ranges above, there may be a maximized or increased effect of a reduction in gas generation and suppression of resistance increase at high temperatures.

The additive represented by Chemical Formula 1 above may include an —OPO— functional group. The —OPO— functional group may stabilize a thermal decomposition product of the lithium salt or an anion dissociated from the lithium salt to thereby reduce gas generation in the battery. For example, the —OPO— functional group may reduce HF gas generation by stabilizing PF₅⁻ generated if (e.g., when) LiPF₆ is thermally decomposed.

The —OPO— functional group included in the additive represented by Chemical Formula 1 may be derived from cyclic phospholane. Compared to a linear phosphite derivative, the cyclic phospholane derivative may cause a rechargeable lithium battery to have a significant improvement in lifetime characteristics. The linear phosphite may not be suitable for high temperature due to its ability to induce a side reaction of LiPF₆ due to a dissociated —PO₂— functional group to cause gas generation resulting from a decomposition reaction that occurs in the electrolyte at high-temperature storage and its low capability to form a solid electrolyte interface (SEI) layer.

The additive represented by Chemical Formula 1 above may include a pyrazole functional group. The pyrazole group may be a compound with string polarity and may be advantageously used as an additive of a rechargeable lithium battery due to its high solubility for an electrolyte using a polar solvent such as ethylene carbonate.

In addition, a lone pair of electrons in nitrogen (N) of the pyrazole group may act on Lewis acid (e.g., PF₅) possibly present in the electrolyte, thereby stabilizing the Lewis acid. This may reduce a substantially continuous decomposition reaction of the lithium salt to prevent or reduce the electrolyte from becoming acidic. The lone pair of electrons of the pyrazole group may stabilize a transition metal on a surface of the positive electrode and a transition metal released from the surface of the positive electrode. This may prevent or reduce a deterioration of the positive electrode to increase a lifetime of the battery.

The pyrazole group may be an amphoteric substance to act as acid or base. The acidity of the pyrazole group may be originated from an —NH group and may be a cause of battery deterioration. The additive according to the present disclosure may allow nitrogen (N) in the pyrazole group to be directly covalently bonded to phosphorus (P). In this case, because the —NH group of the pyrazole group is eliminated, only basicity of the pyrazole group may be effectively used.

Compared to imidazole, the pyrazole functional group included in the additive represented by Chemical Formula 1 above may significantly improve high-temperature characteristics of the rechargeable lithium battery. Pyrazole may indicate 1,2-diazacyclopenta-2,4-diene, and imidazole may indicate 1,3-diazacyclopenta-2,4-diene.

The additive according to one or more embodiments of the present disclosure may include both (e.g., simultaneously) of the —OPO— functional group and the pyrazole functional group, and thus may exhibit an excellent or suitable effect of suppression or reduction in resistance increase and reduction in gas generation.

An improvement in high-temperature stability of the rechargeable lithium battery caused by the additive represented by Chemical Formula 1 above may become even more pronounced if (e.g., when) the additive is used together with a high nickel-based positive electrode active material and a negative electrode active material including a silicon-carbon composite. For example, silicon particles may be utilized to increase battery capacity, but there may be a problem of an increase in battery internal resistance due to a side reaction between the silicon particles and the electrolyte. Because the additive suppresses the side reaction between the silicon particles and the electrolyte, an increase in battery internal resistance may be minimized or reduced and an increase in battery capacity may be maximized or increased.

### Rechargeable Lithium Battery

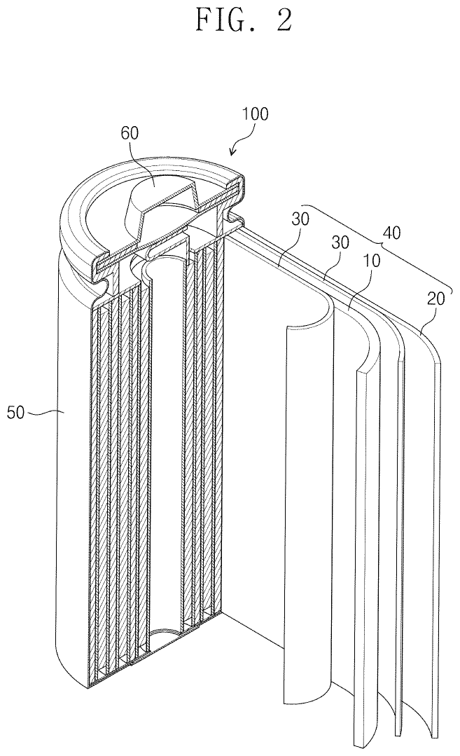

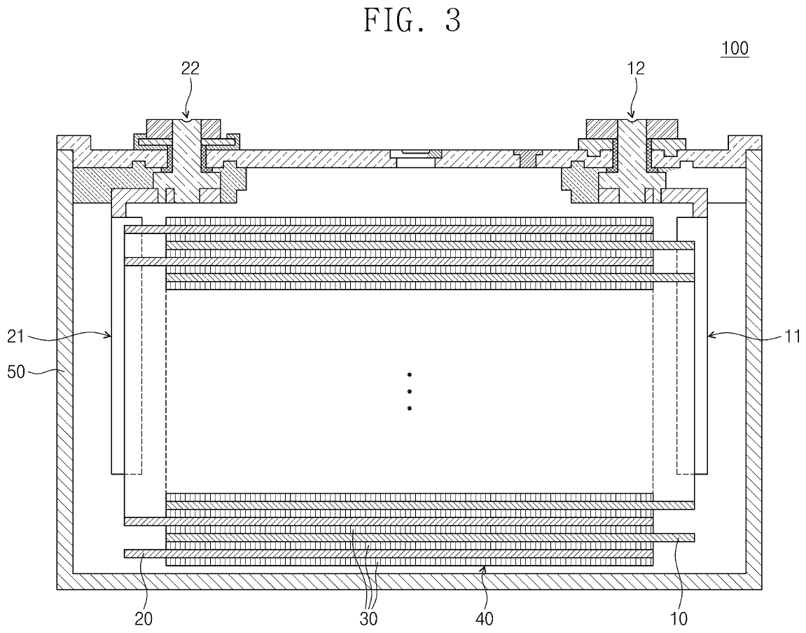

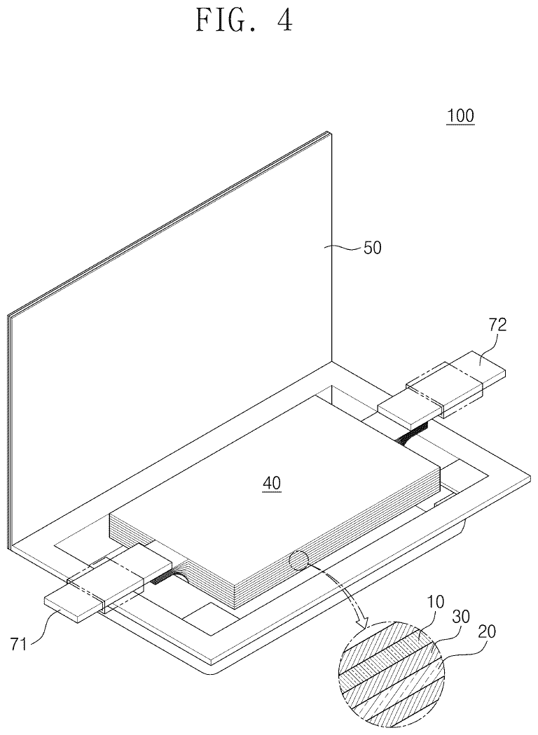

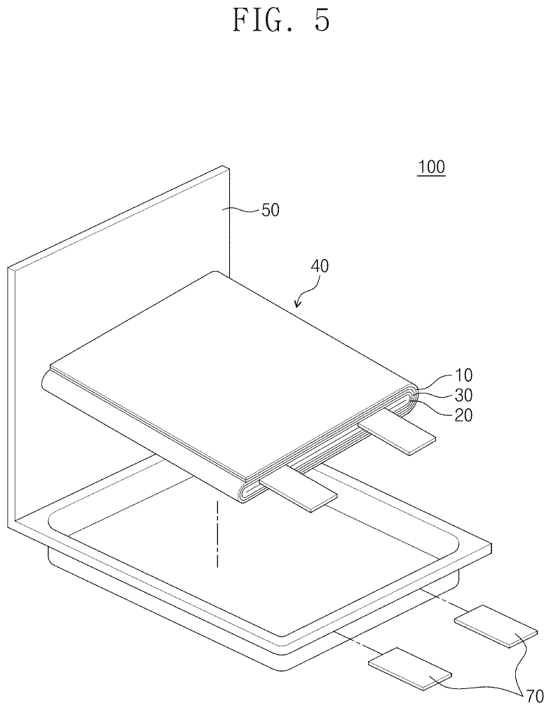

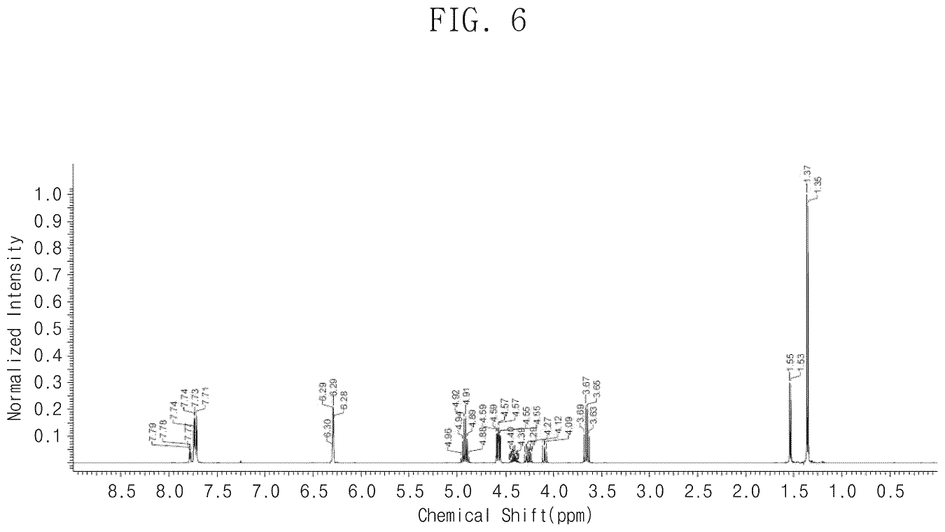

Based on a shape of a rechargeable lithium battery, the rechargeable lithium battery may be classified into cylindrical, prismatic, pouch, and coin types (kinds). In FIGS. 2 to 5 illustrating diagrams each showing a rechargeable lithium battery according to one or more embodiments, FIG. 2 shows a cylindrical battery, FIG. 3 shows a prismatic battery, and FIGS. 4 and 5 each show pouch-type or kind batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, or a positive electrode tab 71 and a negative electrode tab 72, which electrode tab 70 serves as an electrical path for externally inducing a current generated in the electrode assembly 40.

A rechargeable lithium battery according to one or more embodiments of the present disclosure may be applied to automotive vehicles, mobile phones, and/or any other electrical devices, but the present disclosure is not limited thereto.

A rechargeable lithium battery according to the present disclosure may include a positive electrode including a positive electrode active material, a negative electrode including a negative electrode active material, and the aforementioned electrolyte for the rechargeable lithium battery.

The positive electrode active material may include lithium composite oxide represented by Chemical Formula 3.

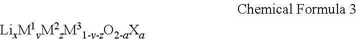

In Chemical Formula 3, x, y, z, and a may satisfy 0.5≤x≤1.8, 0≤a≤0.05, 0<y≤1, 0≤z≤1, and 0≤y+z≤1.

M¹, M², and M³ may each independently include at least one element selected from among metals such as Ni, Co, Mn, Al, B, Ba, Ca, Ce, Cr, Fe, Mo, Nb, Si, Sr, Mg, Ti, V, W, Zr, La, and/or a (e.g., any suitable) combination thereof.

X may include at least one element selected from among F, S, P, and Cl.

In one or more embodiments, in Chemical Formula 3 above, M¹ may be Ni, y may be 0.8≤y≤1, and z may be 0≤z≤0.2. In one or more embodiments, in Chemical Formula 3, M¹ may be Ni, M² may be Co, and M³ may be Al. Dissimilarly, in Chemical Formula 3, M¹ may be Ni, M² may be Co, and M³ may be Mn.

In one or more embodiments, the positive electrode active material of the rechargeable lithium battery may include nickel, cobalt, and aluminum. In one or more embodiments, the positive electrode active material of the rechargeable lithium battery may include nickel, cobalt, and manganese.

The negative electrode active material may be a carbon-based negative electrode active material, a Si-based negative electrode active material, a Sn-based negative electrode active material, and/or a (e.g., any suitable) combination thereof.

In one or more embodiments, the Si-based negative electrode active material may be a silicon-carbon composite.

When the positive electrode includes a high nickel-based positive electrode active material, and if (e.g., when) the negative electrode includes a silicon-carbon composite, the rechargeable lithium battery may maximally improve in high-temperature stability. The rechargeable lithium battery composed of such combination may operate even at high voltages of equal to or greater than about 4.2 V.

In the rechargeable lithium battery according to one or more embodiments of the present disclosure, a non-aqueous electrolyte may be decomposed during an initial charge-discharge to form a film having passivation ability on the surfaces of the positive and negative electrodes to improve high-temperature storage characteristics. The film may be deteriorated due to acids such as HF⁻ and/or PF₅⁻ produced by thermal decomposition of lithium salts (LiPF₆ and/or the like) used in lithium ion batteries. This acid attack may elute transition metal elements from the positive electrode and increase a surface resistance of the electrode caused by a structural change of the surface. Thus, a theoretical capacity may be reduced due to loss of metal elements which are redox (reduction and oxidation) centers, which may result in a reduction in capacity. In addition, the eluted transition metal ions may be electrodeposited on the negative electrode that reacts in a strong reduction potential range. Therefore, electrons may be consumed and the film may be destroyed during the electrodeposition, and accordingly the surface of the negative electrode may be exposed to cause an additional electrolyte decomposition reaction. There may thus be an increase in resistance of the negative electrode and in irreversible capacity, and as a result, there may be a problem of substantially continuous reduction in cell capacity.

In the present disclosure, the —OPO— functional group and the pyrazole functional group of the additive represented by Chemical Formula 1 above may provide an unshared electron pair to capture PF₅⁻ and stabilize a LiPF₆ salt, with the result that it may be possible to remove the acid(s) led (produced) by decomposition of the lithium salt in the electrolyte.

In addition, the —OPO— functional group and the pyrazole functional group of the additive represented by Chemical Formula 1 above may stabilize transition metal on the surface of the positive electrode and transition metal released from the surface of the positive electrode, and thus the rechargeable lithium battery may improve in high-temperature stability.

The following will describe Examples (Embodiments) and Comparative Examples of the present disclosure. The following Examples (Embodiments), however, are merely examples, and the present disclosure is not limited to the Embodiments discussed.

### Synthesis Example 1

To 40 mL of petroleum ether containing 5.61 g (0.04 mol) of 1-(trimethylsilyl)-1H-pyrazole, 5.62 g (0.04 mol) of 2-chloro-4-methyl-1,3,2-dioxaphospholane was added dropwise and stirred for 10 minutes at room temperature (25° C.) under an inert atmosphere. The reaction mixture was stirred for 24 hours to evaporate a volatile component, and then a residue was fractionated under 3 Torr at 77° C. to obtain a compound represented by Chemical Formula 2.

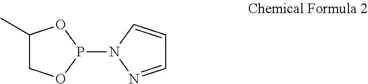

### Embodiment 1

### (1) Preparation of Electrolyte

1.5M LiPF₆ was dissolved in a non-aqueous organic solvent containing ethylene carbonate (EC), ethylmethyl carbonate (EMC), and dimethyl carbonate (DMC) mixed in a volume ratio of about 20:10:70, and the additive represented by Chemical Formula 2 obtained in Synthesis Example 1 was added to prepare an electrolyte.

An amount of the additive was about 0.5 parts by weight relative to 100 parts by weight of the electrolyte.

### (2) Fabrication of Rechargeable Lithium Battery

LiNi_{0.91}Co_{0.07}Al_{0.02}O₂ as a positive electrode active material, polyvinylidene fluoride as a binder, and Ketjenblack as a conductive material were mixed in a weight ratio of 97:2:1, and the mixture was dispersed in N-methyl pyrrolidone to prepare a positive electrode active material slurry.

The positive electrode active material slurry was coated on an aluminum current collector of 14 μm in thickness, dried at 110° C., and then pressed to manufacture a positive electrode.

Artificial graphite and silicon nano-particles mixed in a weight ratio of 93:7 as a negative electrode active material, styrene butadiene rubber (SBR) as a binder, and carboxymethyl cellulose (CMC) as a thickener were mixed in a weight ratio of 97:1:2, and the mixture was distributed in distilled water to prepare a negative electrode active material slurry.

The negative electrode active material slurry was coated on a copper current collector of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Embodiment 2

An electrolyte and a rechargeable lithium battery were fabricated in substantially the same method as in Embodiment 1, except that an amount of the additive was 1 part by weight relative to 100 parts by weight of the electrolyte.

### Embodiment 3

An electrolyte and a rechargeable lithium battery were fabricated in substantially the same method as in Embodiment 1, except that an amount of the additive was 3 parts by weight relative to 100 parts by weight of the electrolyte.

### Embodiment 4

An electrolyte and a rechargeable lithium battery were fabricated in substantially the same method as in Embodiment 1, except that an amount of the additive was 5 parts by weight relative to 100 parts by weight of the electrolyte.

### Comparative Example 1

An electrolyte and a rechargeable lithium battery were fabricated in substantially the same method as in Embodiment 1, except that an additive represented by Chemical Formula 4 was added and that an amount of the additive was 2 parts by weight relative to 100 parts by weight of the electrolyte.

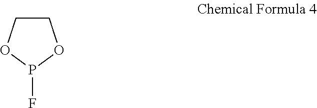

### Comparative Example 2

An electrolyte and a rechargeable lithium battery were fabricated in substantially the same method as in Embodiment 1, except that no additive is added.

### Evaluation Example 1: Resistance Increase Rate at High-Temperature Storage

The rechargeable lithium batteries fabricated in Embodiments and Comparative Examples were charged at 25° C. with 0.33 C-rate and 4.25 V, and an initial battery resistance value and a battery resistance value after being left for 60 days at 55° C. were measured. A resistance increase rate was measured and the result was listed in Table 1. The resistance values were measured by using electrochemical impedance spectroscopy (EIS).

The resistance increase rate was calculated according to Equation 1.

$$Resistance increase rate ( \% ) = ( resistance after 60 days / initial resistance ) \times 100 \qquad Equation 1$$

### Evaluation Example 2: Gas Generation at High-Temperature Storage

The rechargeable lithium batteries fabricated in Embodiments and Comparative Examples were charged at 25° C. with 4.25 V, left at 55° C. for 60 days, and then refinery gas analysis (RGA) was utilized to measure a gas generation amount (mL). The result was listed in Table 1.

TABLE 1

| | | | Evaluation Result | |
|---|---|---|---|---|
| | Amount | | Resistance | Gas |
| | Chemical | Chemical | Increase | Generation |
| | Formula 2 | Formula 4 | Rate | Amount |
| | (wt %) | (wt %) | (%) | (mL) |
| Comparative | 0 | 2 | 20.2 | 37.3 |
| Example 1 | | | | |
| Comparative | 0 | 0 | 21.9 | 39.8 |
| Example 2 | | | | |
| Embodiment 1 | 0.5 | 0 | 12.1 | 22.0 |
| Embodiment 2 | 1 | 0 | 10.4 | 18.9 |
| Embodiment 3 | 3 | 0 | 13.9 | 25.2 |
| Embodiment 4 | 5 | 0 | 20.3 | 36.9 |

Referring to Table 1, it may be observed that the resistance increase rate at a high-temperature (55° C.) is similar or less in the cases (Embodiments 1 to 4) that each use an electrolyte including the additive according to the present disclosure than in the case (Comparative Example 1) that uses an electrolyte including the additive represented by Chemical Formula 4 and the case (Comparative Example 2) that uses an electrolyte including no additive. For example, it may be ascertained that Embodiments 1 to 4 have an excellent or suitable effect of suppression or reduction in resistance increase rate of batteries.

Referring to Table 1, it may be observed that the gas generation amount at a high-temperature (55° C.) is less in the cases (Embodiments 1 to 4) that use an electrolyte including the additive according to the present disclosure than in the case (Comparative Example 1) that uses an electrolyte including the additive represented by Chemical Formula 4 and the case (Comparative Example 2) that uses an electrolyte including no additive. For example, it may be ascertained that Embodiments 1 to 4 have an excellent or suitable effect of reduction in gas generation.

An electrolyte for a rechargeable lithium battery according to one or more embodiments may exhibit an effect of suppression or reduction in internal resistance increase and reduction in gas generation. The effect may become pronounced at high temperatures.

A battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the one or more suitable components of the device may be formed on one integrated circuit (IC) chip or on separate IC chips. Further, the one or more suitable components of the device may be implemented on a flexible printed circuit film, a tape carrier package (TCP), a printed circuit board (PCB), or formed on one substrate. Further, the one or more suitable components of the device may be a process or thread, running on one or more processors, in one or more computing devices, executing computer program instructions and interacting with other system components for performing the one or more suitable functionalities described herein. The computer program instructions are stored in a memory which may be implemented in a computing device utilizing a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

While this disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims, equivalents thereof, and therefore the aforementioned embodiments should be understood to be exemplarily but not limiting this disclosure in any way.

What is claimed is:

1. An electrolyte comprising:
a non-aqueous organic solvent;
a lithium salt; and
an additive represented by Chemical Formula 1, 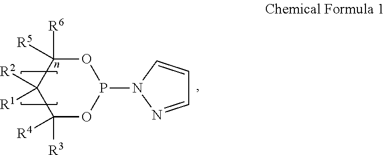
wherein, in Chemical Formula 1,
R¹ to R⁶ are each independently hydrogen, a substituted or unsubstituted C1 to C20 alkyl group, a substituted or unsubstituted C1 to C20 alcoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is an integer of 0 or 1, and
wherein the electrolyte is for a rechargeable lithium battery.

2. The electrolyte as claimed in claim 1, wherein Chemical Formula 1 is represented by Chemical Formula 1A or Chemical Formula 1B, 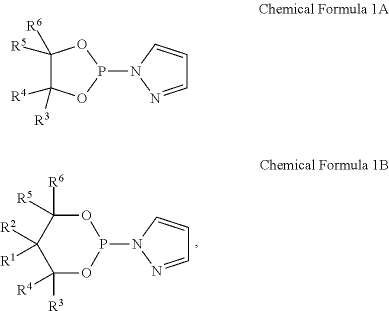
wherein, in Chemical Formula 1A and Chemical Formula 1B,
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

3. The electrolyte as claimed in claim 2, wherein
each of R³ and R⁴ of Chemical Formula 1A is hydrogen, and
at least one selected from among R⁵ and R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The electrolyte as claimed in claim 1, wherein the additive represented by Chemical Formula 1 is at least one selected from among compounds listed in Group 1,

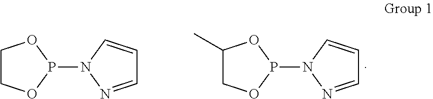

5. The electrolyte as claimed in claim 1, wherein an amount of the additive is about 0.01 to about 5.0 parts of weight relative to 100 parts by weight of the electrolyte for the rechargeable lithium battery.

6. The electrolyte as claimed in claim 1, wherein the non-aqueous organic solvent comprises a carbonate-based solvent.

7. The electrolyte as claimed in claim 6, wherein the carbonate-based solvent comprises ethylmethyl carbonate (EMC), ethylene carbonate (EC), and dimethyl carbonate (DMC).

8. The electrolyte as claimed in claim 7, wherein the carbonate-based solvent comprises ethylmethyl carbonate (EMC), ethylene carbonate (EC), and dimethyl carbonate (DMC) have a volume ratio of 1:a:b, and
wherein a is about 1 to about 3, and
b is about 5 to about 8.

9. The electrolyte as claimed in claim 1, wherein the lithium salt comprises LiPF₆.

10. The electrolyte as claimed in claim 1, wherein a concentration of the lithium salt is in a range of about 0.1 M to about 2.0 M.

11. A compound represented by Chemical Formula 2,

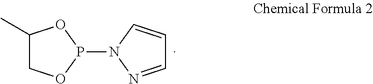

12. A rechargeable lithium battery, comprising:
a positive electrode that comprises a positive electrode active material;
a negative electrode that comprises a negative electrode active material; and
the electrolyte as claimed in claim 1.

13. The rechargeable lithium battery as claimed in claim 12, wherein the positive electrode active material comprises lithium composite oxide represented by Chemical Formula 3, 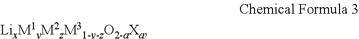
wherein 0.5≤x≤1.8, 0≤a≤0.05, 0<y≤1, 0≤z≤1, and 0≤y+z≤1,
wherein M¹, M², and M³ each independently comprise at least one element selected from among metals such as Ni, Co, Mn, Al, B, Ba, Ca, Ce, Cr, Fe, Mo, Nb, Si, Sr, Mg, Ti, V, W, Zr, La, and a combination thereof, and
wherein X comprises at least one element selected from among F, S, P, and Cl.

14. The rechargeable lithium battery as claimed in claim 12, wherein, in Chemical Formula 3, M¹ is Ni, y is 0.8≤y≤1, and z is 0≤z≤0.2.

15. The rechargeable lithium battery as claimed in claim 12, wherein the rechargeable lithium battery is configured to operate even at a high voltage of equal to or greater than about 4.2 V.

16. The rechargeable lithium battery as claimed in claim 12, wherein the negative electrode active material comprises a carbon-based negative electrode active material, a Si-based negative electrode active material, a Sn-based negative electrode active material, or a combination thereof.
